(19) United States
(12) Patent Application Publication
(10) Pub. No.: US 2017/0199290 A1
(43) Pub. Date: Jul. 13, 2017

(54) SYSTEMS AND METHODS FOR ATTENUATING NOISE USING INTERFEROMETRIC ESTIMATION

(71) Applicant: CGG SERVICES SAS, Massy Cedex (FR)

(72) Inventors: Pierre-François ROUX, Grenoble (FR); Julien MEUNIER, Paris (FR)

(21) Appl. No.: 15/326,718

(22) PCT Filed: Jul. 21, 2014
(86) PCT No.: PCT/IB2014/001534

§ 371 Date: Jan. 17, 2017

(51) Int. Cl. G01V 1/36

(52) U.S. Cl. CPC G01V 1/366; G01V 2210/32; G01V 2210/52

(57) ABSTRACT

Systems and methods are disclosed for attenuating noise during seismic acquisition. The method includes compiling a seismic data set from data received by a plurality of receivers. The seismic data set includes noise energy from a noise source. The method further includes calculating a plurality of cross-correlation panels based on a reference trace from a reference receiver. The reference receiver is one of the plurality of receivers. The method includes estimating the location of the noise source and applying a correction to the plurality of cross-correlation panels based on the estimated location of the noise source generating a plurality of corrected panels. The method also includes analyzing the plurality of corrected panels for a noise operator to attenuate noise in the seismic data set.

### TECHNICAL FIELD

The present invention relates generally to seismic exploration and, more particularly, to attenuating noise using interferometric estimation.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected, refracted, diffracted or otherwise affected by one or more geologic structures within the earth, for example, by interfaces between underground formations having varying acoustic impedances. The reflections are recorded by seismic detectors, or “receivers,” located at or near the surface of the earth, in a body of water, or at known depths in boreholes, and the resulting seismic data can be processed to yield information relating to the location and physical properties of the subsurface formations. Seismic data acquisition and processing generates a profile, or image, of the geophysical structure under the earth's surface. While this profile does not provide a specific location for oil and gas reservoirs, it suggests, to those trained in the field, the presence or absence of them.

Various sources of seismic energy have been used to impart the seismic waves into the earth. Such sources have included two general types: 1) impulsive energy sources and 2) seismic vibrator sources. The first type of geophysical prospecting utilizes an impulsive energy source, such as dynamite or a marine air gun, to generate the seismic signal. With an impulsive energy source, a large amount of energy is injected into the earth in a very short period of time. In the second type of geophysical prospecting, a vibrator is used to propagate energy signals over an extended period of time, as opposed to the near instantaneous energy provided by impulsive sources. Except where expressly stated herein, “source” is intended to encompass any seismic source implementation, both impulse and vibratory, including any dry land or marine implementations thereof.

The seismic signal is emitted in the form of a wave that is reflected off interfaces between geological layers. The reflected waves are received by an array of seismic receivers, or “receivers,” located at the earth's surface, which convert the displacement of the ground resulting from the propagation of the waves into an electrical signal recorded by means of a computing system. Receivers may be arranged in cable-based receiver network or array where receivers are connected to each other via a cable, or “strings.” The receivers typically receive data during the source's energy emission and during a subsequent “listening” interval. Data received by the receivers is transmitted to a computing system. The computing system records the time at which each reflected wave is received. The travel time from source to receiver, along with the velocity of the source wave, can be used to reconstruct the path of the waves to create an image of the subsurface. A large amount of data may be recorded by the computing system and the recorded signals may be subjected to signal processing before the data is ready for interpretation. The recorded seismic data may be processed to yield information relating to the location of the subsurface reflectors and the physical properties of the subsurface formations. That information is then used to generate an image of the subsurface.

Once hydrocarbon reservoirs have been put into production, it is often useful to be able to obtain ongoing seismic measurements to monitor characteristics of the underground hydrocarbon reservoir over time. Two types of seismic exploration, continuous seismic monitoring and 4D seismic monitoring, involve multiple sources and receivers that are in use for an extended period of time. In continuous seismic monitoring, sources and receivers may continually operate for months or years to monitor changes in a reservoir or other subsurface formation. In 4D seismic monitoring, also called “time-lapse monitoring,” sources and receivers repeat a seismic survey over a defined time interval. Each survey can be performed hours, days, weeks, or months apart. 4D seismic monitoring also monitors changes in a reservoir or other subsurface formation. Equipment, such as receivers, may be permanently deployed over an area to provide repeatable 4D and continuous seismic monitoring. Such equipment may be part of a permanent reservoir monitoring (PRM) system.

Several types of machinery, e.g., pumps and injectors, are often located on pads of fields that are recovering the hydrocarbons from the underground hydrocarbon reservoir. However, the machinery can generate large amounts of noise that can be problematic with ongoing seismic monitoring applications. Additionally, in ocean bottom monitoring, ships passing over the receiver network can generate noise that contributes to and interferes with the seismic signals detected at the receivers. Both fixed and moving noise sources can increase the difficulty of obtaining the actual reflected seismic signals of interest. Thus, it would be useful to provide systems and methods that improve the identification and attenuation or removal of noise energy from the received seismic data.

### SUMMARY

In one embodiment, a method is disclosed for attenuating noise during seismic acquisition. The method includes compiling a seismic data set from data received by a plurality of receivers. The seismic data set includes noise energy from a noise source. The method further includes calculating a plurality of cross-correlation panels based on a reference trace from a reference receiver. The reference receiver is one of the plurality of receivers. The method includes estimating the location of the noise source and applying a correction to the plurality of cross-correlation panels based on the estimated location of the noise source generating a plurality of corrected panels. The method also includes analyzing the plurality of corrected panels for a noise operator to attenuate noise in the seismic data set.

In another embodiment, a seismic processing system includes a plurality of receivers configured to receive seismic data and a computing system communicatively coupled to the plurality of receivers. The computing system is configured to compile a seismic data set from data received by the plurality of receivers. The seismic data set includes noise energy from a noise source. The computing system is further configured to cause a processor to calculate a plurality of cross-correlation panels based on a reference trace from a reference receiver, estimate the location of the noise source, and apply a correction to the plurality of cross-correlation panels based on the estimated location of the noise source generating a plurality of corrected panels. The reference receiver is one of the plurality of receivers. The computing system is also configured to analyze the plurality of corrected panels for a noise operator to attenuate noise in the seismic data set.

In another embodiment, a non-transitory computer-readable medium is disclosed that includes computer-executable instructions carried on the computer-readable medium. The instructions, when executed, cause a processor to compile a seismic data set from data received by the plurality of receivers. The seismic data set includes noise energy from a noise source. The instructions further cause a processor to calculate a plurality of cross-correlation panels based on a reference trace from a reference receiver, estimate the location of the noise source, and apply a correction to the plurality of cross-correlation panels based on the estimated location of the noise source generating a plurality of corrected panels. The reference receiver is one of the plurality of receivers. The instructions also cause a processor analyze the plurality of corrected panels for a noise operator to attenuate noise in the seismic data set.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates a schematic diagram of an example ocean bottom cable (OBC) acquisition exploration network in accordance with some embodiments of the present disclosure;

FIG. 2 illustrates a graph indicating example noise energy based on a cross-correlation between a particular receiver and a string of receivers in accordance with some embodiments of the present disclosure;

FIG. 3 illustrates a graph of a calendar cross-correlation of a particular receiver pair in accordance with some embodiments of the present disclosure;

FIG. 4 illustrates a graph of a cross-correlation panel for a reference trace from a reference receiver correlated with traces from other receivers in a network in accordance with some embodiments of the present disclosure;

FIG. 5 illustrates a graph of a move out (MO) corrected panel in accordance with some embodiments of the present disclosure;

FIG. 6 illustrates a graph of an MO corrected panel based on relocation of a noise source's estimated location in accordance with some embodiments of the present disclosure;

FIG. 7 illustrates a graph of a stacked panel in accordance with some embodiments of the present disclosure;

FIG. 8 illustrates a graph of an averaged stacked panel in accordance with some embodiments of the present disclosure;

FIG. 9 illustrates a graph of noise operator in accordance with some embodiments of the present disclosure;

FIGS. 10A and 10B illustrate graphs of a cross-correlation of a noise operator with a row stack in accordance with some embodiments of the present disclosure;

FIG. 11 illustrates a flow chart of an example method of attenuating noise using interferometric estimation in accordance with some embodiments of the present disclosure; and

FIG. 12 illustrates a schematic diagram of an example system that can be used to attenuate noise using interferometric estimation in accordance with some embodiments of the present disclosure.

### DETAILED DESCRIPTION

In seismic data processing, sound or seismic waves can be used in support of identification and exploitation of hydrocarbon reservoirs. However, when noise sources are moving or fixed in proximity to a receiver network—such as fixed machinery or passing ships—noise energy can interfere with reception of the seismic waves by receivers. In some embodiments, the impact of the noise can be minimized or removed from the received signals. One method for attenuating noise from fixed locations is described in U.S. Patent Application Publication 2013/0077438 titled “Methods and Systems for Attenuating Noise Generated at Fixed Locations,” the disclosure of which is hereby incorporated herein by reference.

Interferometry is a family of techniques in which waves are superimposed in order to extract information about the waves. Seismic interferometry uses cross-correlation of signal pairs to reconstruct the response to a seismic wave. In some embodiments, interferometric estimation of a response between noise energy from a synthesized, virtual noise source and a network of receivers may be useful to attenuate the impact of the noise source. Noise energy may be any unwanted signal or seismic energy received from other than primary reflections, for example, from a noise source. A noise source could be machinery such as a pump, engine, generator, or any other item that generates noise energy. A virtual noise source may be a created version of one or more actual noise sources that approximately replicate the noise energy received from the one or more actual noise sources. The construction of a noise operator can allow the noise energy generated by the noise source to be attenuated or removed from the seismic data.

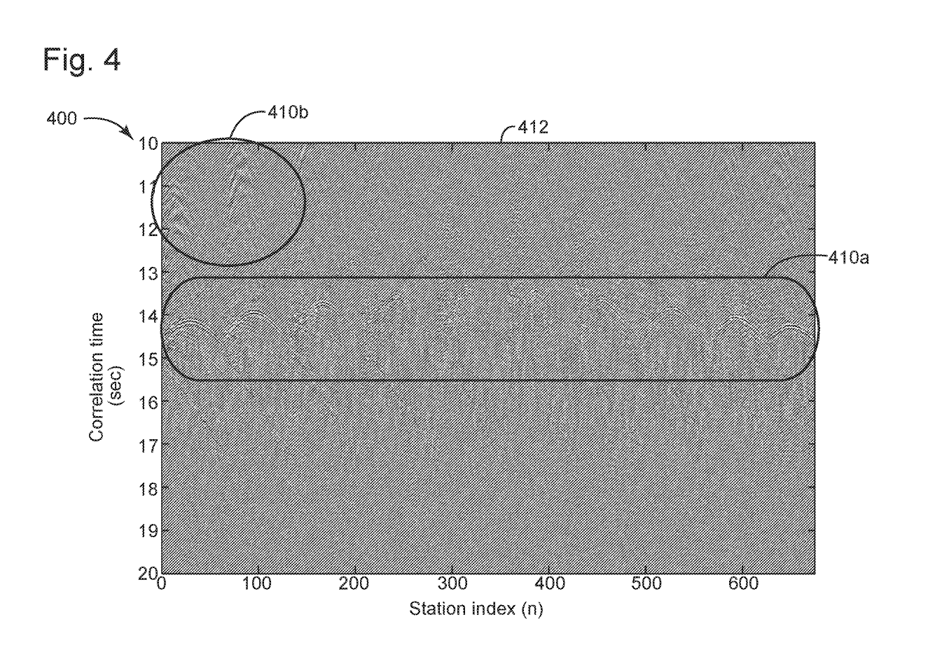

In some embodiments, interferometric estimation can generally include estimation of the noise source's location or position. The noise source's signature, or distinctive waveshape, can be synthesized by processing seismic data, as described in detail in FIGS. 4-9 below. The impact of the synthesized signature on the receivers can be estimated and removed from the seismic data. Thus, seismic interferometry can be used to attenuate noise energy generated by noise sources in seismic data.

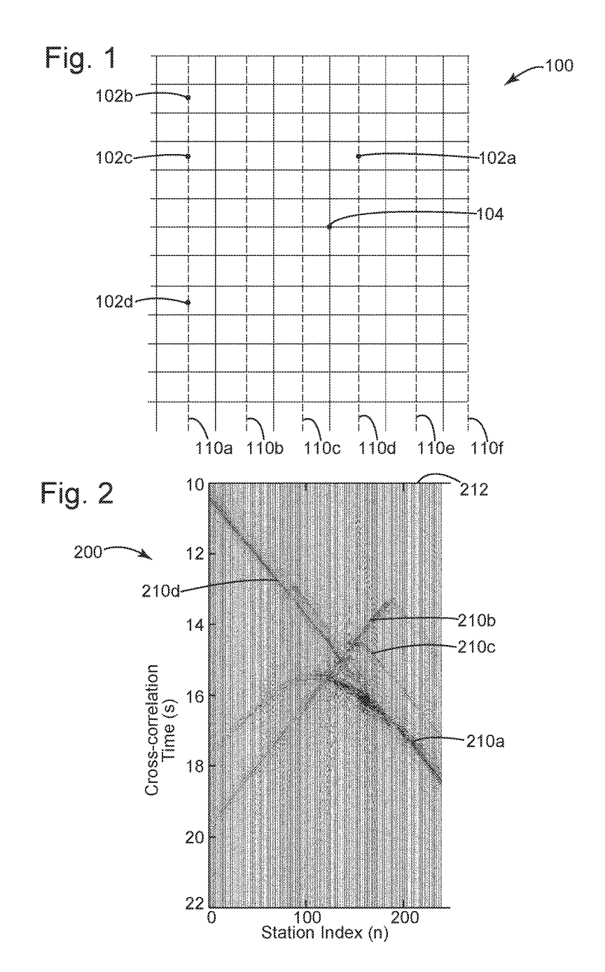

FIG. 1 illustrates a schematic diagram of an example ocean bottom cable (OBC) acquisition exploration network 100 in accordance with some embodiments of the present disclosure. A survey of the acquisition area typically includes activation of a seismic source that radiates an elastic wavefield that expands downwardly through the layers beneath the earth's surface. The seismic wavefield is reflected, refracted, or otherwise returned from the respective layers as a wavefront or head wave recorded by receivers 102a-102d (collectively, “receivers 102”).

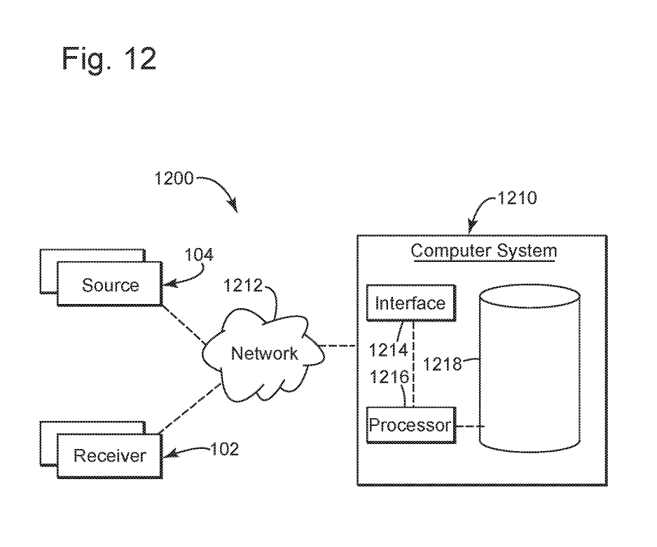

In some embodiments, source 104 is controlled to generate seismic waves in a seismic survey, and receivers 102 receive waves reflected by subsurface layers, oil or gas reservoirs, or other subsurface formations. Received waves are converted to electrical signals and are communicated to a computer system for processing, as described further below with respect to FIG. 12. Network 100 includes multiple strings 110a-110f (collectively, “strings 110”) containing multiple receivers configured in a grid. For example, network 100 may include approximately 4,000 receivers. Each receiver 102 may be assigned a “station index” to identify the location of that particular receiver 102. Station indexes may be assigned proceeding from south to north or any other suitable assignment method.

In some embodiments, noise signals (and corresponding noise sources) may be identified by cross-correlating traces at two receivers 102. Cross-correlation is a measure of the similarity of two waveforms with a correction for any time lag between the two signals. Thus, cross-correlation of two traces increases the amplitude readings for common points of the two waveforms and neutralizes the amplitude readings for non-common points.

FIG. 2 illustrates graph 200 indicating example noise energy 210 based on a cross-correlation between a particular receiver and a string of receivers in accordance with some embodiments of the present disclosure. Graph 200 may contain data 212 that represents traces recorded for a particular listening interval, shown as cross-correlation time. For example, in a listening interval after the activation of source 104 (shown in FIG. 1), each receiver 102 in network 100 may receive a signal. The listening interval for receiving a signal may be approximately thirty seconds or any suitable duration. The received signal may be recorded as a trace. Each receiver in a particular string 110 or in all strings 110 may be cross-correlated with a reference receiver, such as receiver 102a. The trace generated by reference receiver 102a may be termed a “reference trace.” For example, traces from each receiver 102 in string 110a may be cross-correlated with a reference trace from reference receiver 102a in string 110d. As another example, traces from some or all other receivers 102 may be cross-correlated with a reference trace from reference receiver 102a. In some embodiments, multiple or all receivers 102 in network 100 can be designated successively as reference receivers. For example, traces from each receiver 102 in network 100 can be cross-correlated with traces from every other receiver 102 in network 100.

The cross-correlations for each receiver pair (for example, reference receiver 102a and receiver 102b) may then be summed (or “stacked”) to provide improved resolution. Stacking multiple traces improves the signal to noise ratio (SNR) over non-stacked results because the non-coherent (or non-consistent) data will be stacked out or nullified. The “order” of the stack indicates the number of cross-correlations that are stacked. For example, data 212 in graph 200 is based on an approximately one-hundredth-order stack.

In some embodiments, noise energy 210 may be estimated by correlating m records (Eᵢ, i being the index on records: i ε [[1, m]]),) of n traces (Dᵢⱼ, with j the index on traces: j ε [[1, n]]), among which p traces will be used as reference traces (and are noted Dᵢₖ, with k the index on reference traces: k ε [[1, p]]),). The resulting correlations may be denoted as Cᵢⱼₖ. The correlations are averaged together to form correlation gather Sⱼₖ as follows:

$${S}_{j k} = \frac{1}{m} {\sum }_{i}^{m} {C}_{ijk} \qquad ( 1 )$$

These average correlations may represent the waves from spatially fixed noise sources. Therefore, it may be useful to separate these different waves (denoted Wₒ, o being the index on the wave (i.e., on the noise source; o ε [[1, w]]) composing this correlation gather (Sⱼₖ) and estimate, for each wave, an operator oₒⱼ between a model and each moved-out correlation.

Accordingly, data 212 includes data received from signals based on seismic sources, such as source 104, and signals from noise sources shown as noise energy 210a-210d (collectively “noise energy 210”). Noise sources may be ships crossing network 100, platforms and machinery located close to network 100, or any other sources of noise. From the results shown in graph 200, the noise sources generate approximately correlated energy, meaning that the signals generated by the noise sources overlap partially or completely. Noise sources may be identified and located based on these correlations. For example, there are approximately four noise sources that generated noise energy 210a-210d.

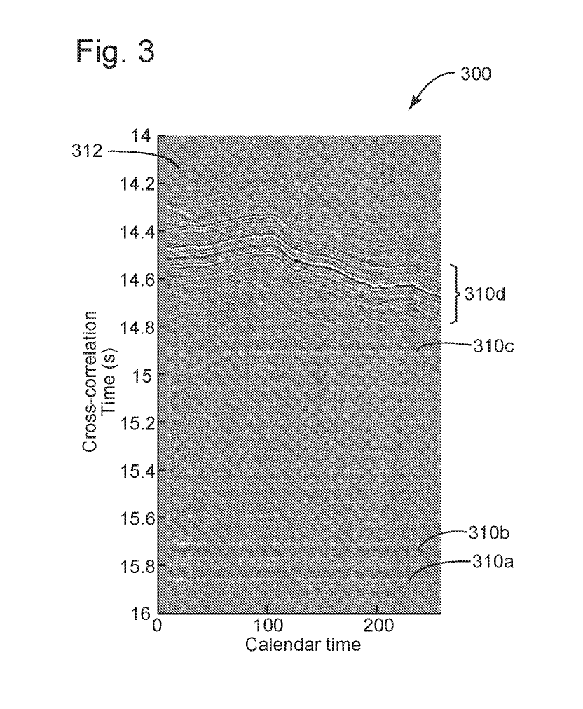

FIG. 3 illustrates graph 300 of a calendar cross-correlation of a particular receiver pair in accordance with some embodiments of the present disclosure. Reviewing data 312 shown in graph 300 may indicate whether noise sources identified in graph 200 shown in FIG. 2 are moving sources or stationary sources. Each trace shown in data 312 may correspond to a Cᵢⱼₖ as noted with reference to Equation (1). Data 312 is generated by cross-correlation of recordings received in a listening interval of approximately thirty seconds from one receiver pair, for example receivers 102a and 102b shown in FIG. 1. Thus, graph 300 is a function of calendar time and cross-correlation (or listening interval) time. Data 312 includes indications of approximately four sources of noise energy, shown as noise energy 310a-310d. Noise energies 310a-310c appear fainter than noise energy 310d. In addition, noise energy 310d has an arrival time (shown as cross-correlation time) that changes over calendar time. Thus, noise energy 310d appears to be from a noise source that is moving in location over calendar time. It can be determined from graph 300 that noise energy 310d is from a moving source, such as a ship or vessel, and noise energies 310a-310c are from stationary noise sources, such as a platform or other fixed machinery. In some embodiments, interferometric estimation may attenuate noise for both moving and fixed sources.

FIG. 4 illustrates graph 400 of cross-correlation panel 412 for a reference trace from a reference receiver correlated with traces from other receivers in a network in accordance with some embodiments of the present disclosure. To generate cross-correlation panel 412 (also referred to as “panel 412”), a particular receiver is selected as the reference receiver, such as reference receiver 102a shown in FIG. 1. Traces from the reference receiver are cross-correlated with traces from some or all other receivers in the network, for example network 100 (see Equation (1)). Panel 412 can be analyzed to determine arrivals of noise energy. Noise energy that is more energetic—has increased amplitude or a difference in frequency over the surrounding signal—may be identified. For example, noise energy 410a with higher amplitude than the surrounding signal may be identified. As another example, lower frequency noise energy 410b may be identified. The contribution of each noise source that produces the noise energy within panel 412 can be assessed to determine each noise source's signature, or distinctive waveshape, and remove it from the seismic data.

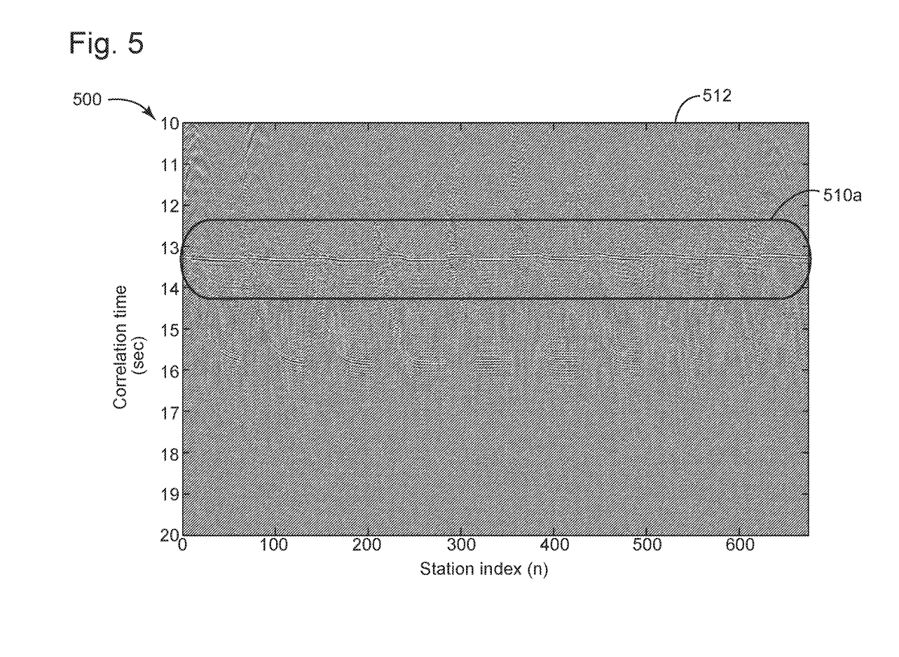

FIG. 5 illustrates graph 500 of move out (MO) corrected panel 512 in accordance with some embodiments of the present disclosure. MO is the variation of arrival times for a wave due to the source to receiver distance. For example, receivers located closer to a source may detect a reflected wave earlier than a receiver located further from a source. Normal move out corrects the seismic data for variation in arrival time in the case of a reflected wave. Additionally, if the propagation between the source and receiver is direct, linear move out (LMO) may be used.

In some embodiments, separating each noise source and estimating corresponding operators may include locating a selected noise source using cross-correlations. This may be accomplished iteratively, until the corresponding arrival in the correlation gather, Sⱼₖ, is relatively flat (as discussed below), For example, an estimated location may be identified for the noise source that generated noise energy 410a, shown in FIG. 4.

A MO correction may be applied to panel 412 based on the estimated location of the noise source. For example, panel 412 may be flattened using the estimated location. The MO correction may be calculated by:

$${S}_{j k}^{flat} = {e}^{\frac{i 2 π f {X}_{o j}}{V ( f )}} \qquad ( 2 )$$

where:
Xₒⱼ=vector joining the source, o, to the receiver, j (or if the noise source is located at the surface, then distance between the source and receiver);
f=frequency; and
V(f)=apparent velocity (which may be frequency-dependent).

The result is shown in MO corrected panel 512. As can be seen from MO corrected panel 512, the resultant noise energy 510a is somewhat flat but not completely or approximately flat. Thus, if noise energy 510a is stacked with other MO corrected panels, noise energy 510a may not stack coherently. As such, the location of the noise source that generated noise energy 510a may be refined by picking, or selecting, noise energy 510a by hand or using an auto-pick tool to enhance the “flattening” of noise energy 510a. Additional information for the location of the noise source (via hand-picking for example) may be accommodated by the following equation:

$${S}_{j k}^{flat} = {e}^{\frac{i 2 π f ( {X}_{o j} + {ɛ}_{j} )}{V ( f )} {S}_{j k}} \qquad ( 3 )$$

where:
εⱼ=additional correction, made on a trace-by-trace (j) basis.

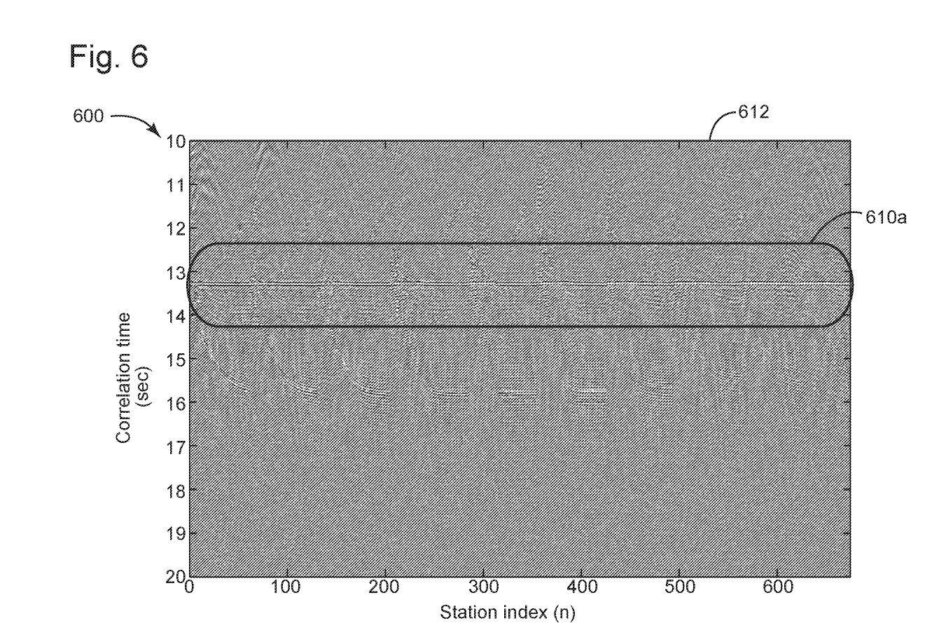

FIG. 6 illustrates graph 600 of MO corrected panel 612 based on a relocation of a noise source's estimated location in accordance with some embodiments of the present disclosure. If an initial MO corrected panel is not sufficiently flat to allow coherent stacking, the estimated location of the noise source may be refined (or the noise source may be “relocated”). The MO correction may be reapplied to the cross-correlated panel 412, shown with reference to FIG. 4, using the updated estimated location of the noise source. Noise source relocation and MO correction may be repeated until the noise energy of interest on the MO corrected panel is sufficiently flat such that the data is approximately consistent over a particular range. For example, noise energy 610a may be sufficiently flat such that noise energy 610a stacks coherently. Sufficient flatness may be based on analyzing the area around the initial estimated location of the noise source and applying a corresponding MO prior to stacking the traces. The point that yields the maximum stack may correspond to the optimum flatness. Sufficient flatness may also be based on cross-correlating each pair of traces in a gather, and then minimizing the standard deviation of the resulting time lags at the maximum correlation.

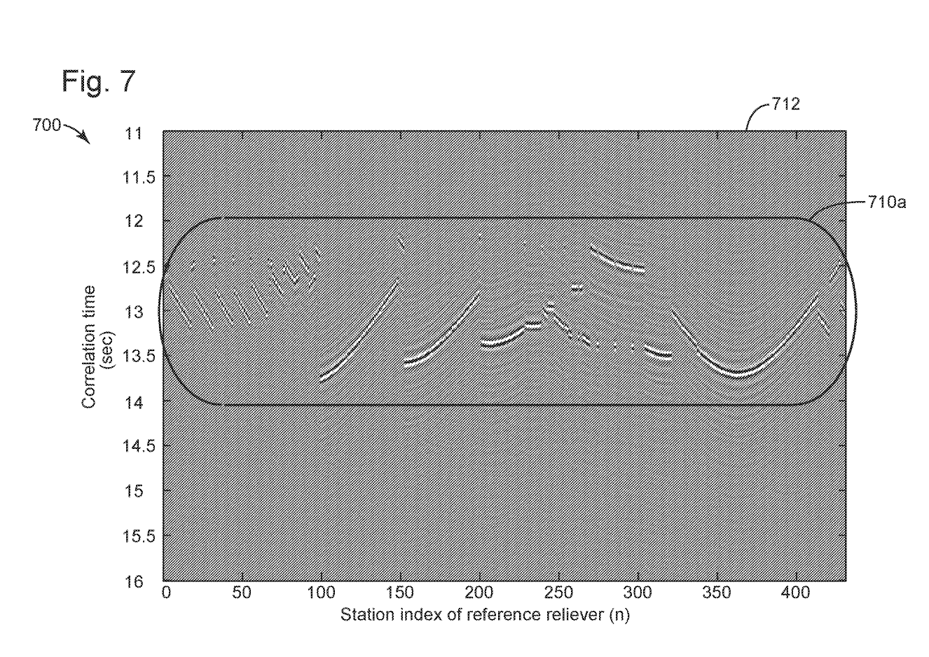

FIG. 7 illustrates graph 700 of stacked panel 712 in accordance with some embodiments of the present disclosure. Panels 412, 512 and 612, shown in FIGS. 4, 5 and 6, respectively, are based on a cross-correlation with a single reference trace. Stacked panel 712 is based on a series of reference traces, or “gather,” that are stacked. Each cross-correlation panel Sⱼₖ is averaged over the trace index j using the following equation:

$${A}_{k} = {\sum }_{j} {S}_{j k}^{flat} \qquad ( 4 )$$

Each of the averages, Aₖ, form a single trace. The set of Aₖ forms a “super cross-correlation gather” shown in stacked panel 712. For example, MO corrections based on an estimated location of a noise source may be applied to multiple cross-correlation panels generated with respect to different reference receivers. The MO corrected panels may then be stacked to create stacked panel 712. Stacked panel 712 may be referred to as a “super cross-correlation gather.”

Noise energy 710a is a function of the station index of the reference receiver used in the cross-correlation. When the individual cross-correlation panels are stacked, additional remaining noise can appear and arrivals can be identified. Stacked panel 712 is used to measure the lag between the flattened correlation panels for different reference traces. Once this is done, the correlation panels may be stacked to further improve the SNR of the noise energy of interest and reduce the other energy (waves) in the cross-correlation gathers. Accordingly, stacked panel 712 may be processed by flattening and further stacking to improve identification of a particular noise source. The additional flattening may be accomplished by estimating the time difference between each cross-correlation panel, for example differences in arrival time, and applying a factor to account for the time difference (also referred to as “phased”). The phased cross-correlation panels may then be stacked, averaged, or otherwise processed to improve isolation of a noise source. The high SNR of the super cross-correlation gather allows the time lag between each of the correlation panels to be measured by using, for instance a cross-correlation between the different Aₖ. The resulting time lags are denoted Tₒₖ, with o corresponding to the wave under scrutiny and k the lag between Aₖ₌₁ and the remainder of the Aₖ.

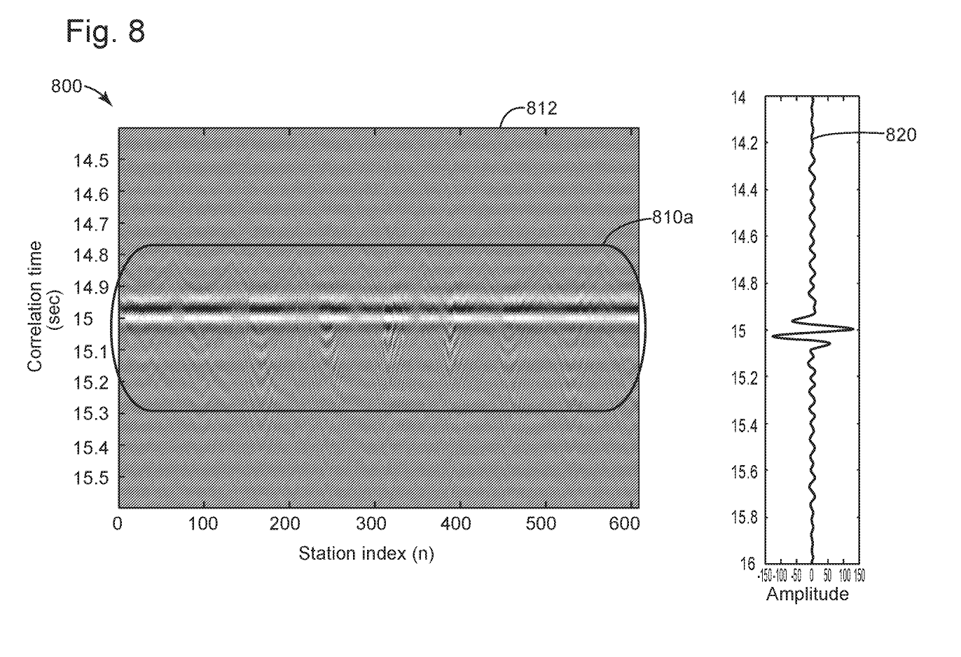

FIG. 8 illustrates graph 800 of averaged stacked panel 812 in accordance with some embodiments of the present disclosure. Each of the MO corrected panels (such as MO corrected panel 512 and 612 discussed with reference to FIGS. 5 and 6, respectively) may be phased to account for time differences between each panel. The phased panels may then be averaged and stacked to result in averaged stacked panel 812. In some embodiments, noise energy 810a may be sufficiently flat such that noise wavelet 820 can be identified. Noise wavelet 820 may be a trace that represents the contribution from a particular noise source to the seismic data.

In some embodiments, cross-correlation panels (corresponding to each reference trace) may be stacked together to further increase the SNR of the noise (wave) to be removed. The result of stacking may be a model Mₒ of the wave to be removed from the gathers:

Mₒ=Σₖe^{i2πfT}^{ₒₖ}(ΣⱼSⱼₖ^{flat}) (5)

FIG. 8 illustrates the stacked cross-correlation panels, ΣₖSⱼₖ^{flat}e^{i2πfT}^{ₒₖ} where k is the index of the reference traces.

In some embodiments, noise wavelet 820 may be deconvolved from averaged cross-correlation panel 812 to result in a noise operator. The noise operator is the interferometric estimation of the impulse response between the found noise-source's location and the receivers—hence the “interferometric estimation.” Deconvolution is removing the effect of areas of overlap between two functions.

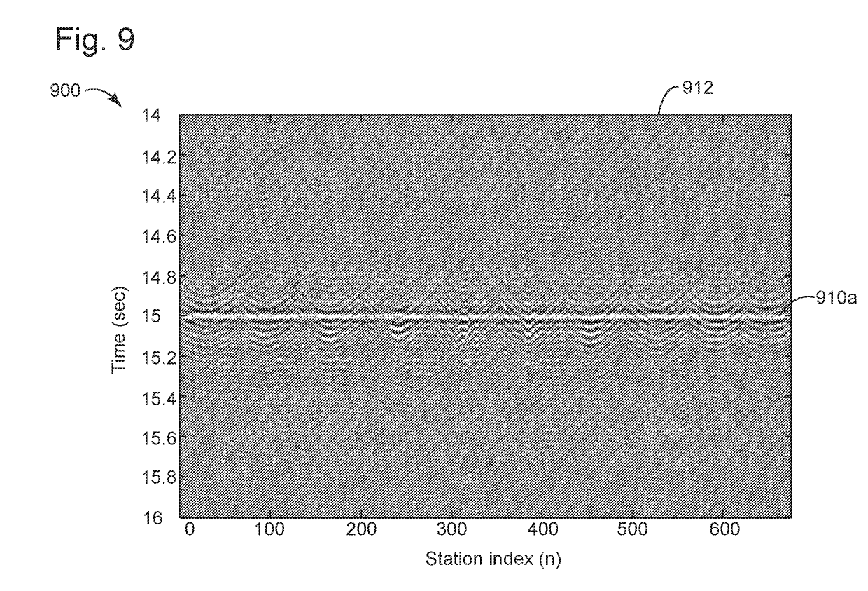

FIG. 9 illustrates graph 900 of noise operator 912 in accordance with some embodiments of the present disclosure. The noise operator for wave o between the interferometric (identified) noise source and each receiver j is given by the equation:

$${O}_{o j} = \frac{{\sum }_{k} {S}_{j k}^{flat} {e}^{i 2 π f {T}_{o k}} }{{M}_{o}} \qquad ( 6 )$$

Noise operator 912 may be relatively flat and still contain some noise (shown as arches around maximum noise 910a). Noise operator 912 may be applied to the seismic data to remove noise energy from the seismic data. For example, for each string 110, discussed with reference to FIG. 1, a gather can be performed and a MO correction can be applied based on the estimated location of the noise source. The result may be referred to as a “row gather.” The different row gathers can be stacked to produce a wavelet. The wavelet can be cross-correlated with noise operator 912 to remove noise from the network. For example, for each recording Dᵢⱼ the MO corresponding to source o may be applied to generate a noise wavelet to which the corresponding operator Oₒⱼ is applied. This yields an estimate of the noise corresponding to source o on traces j. The noise may be removed from the recording, to yield a denoised recording.

Accordingly, in some embodiments, an operator may be built and applied equivalently (the cross-correlation gathers Sⱼₖ can be expressed as a linear combination of models and operators, assuming there is no other source of signal in the correlations—and thus, Sⱼₖ^{flat} is a Dirac impulse):

$${S}_{j k} = {\sum }_{o} {M}_{o} {O}_{o j } {e}^{- \frac{i 2 π f ( {X}_{o j} + {ɛ}_{j} )}{V ( f )}} \qquad ( 7 )$$

In some embodiments, a matrix notation may be utilized to account for all noise sources simultaneously after each noise source has been characterized independently per the present disclosure. Following the notation in Equation (7), it is possible to denote the coefficients

$${O}_{o j} {e}^{- \frac{i 2 π f ( {X}_{o j} + {ɛ}_{j} )}{V ( f )}}$$

as linear factors of the different models Mₒ:

$${a}_{j o} = {O}_{o j} {e}^{- \frac{i 2 π f ( {X}_{o j} + {ɛ}_{j} )}{V ( f )}} .$$

Doing so, the set of Equations (7) for the different waves may be shown by:

Sₖ=AM (8)

where:

Sₖ=an n-rows vector of cross-correlations;

A=the matrix of the coefficients aⱼₒ; and

M=a p-rows vector of models.

Note that this matrix equation is written for one frequency f and based on the number of operators needed, may be written for as many frequencies as necessary.

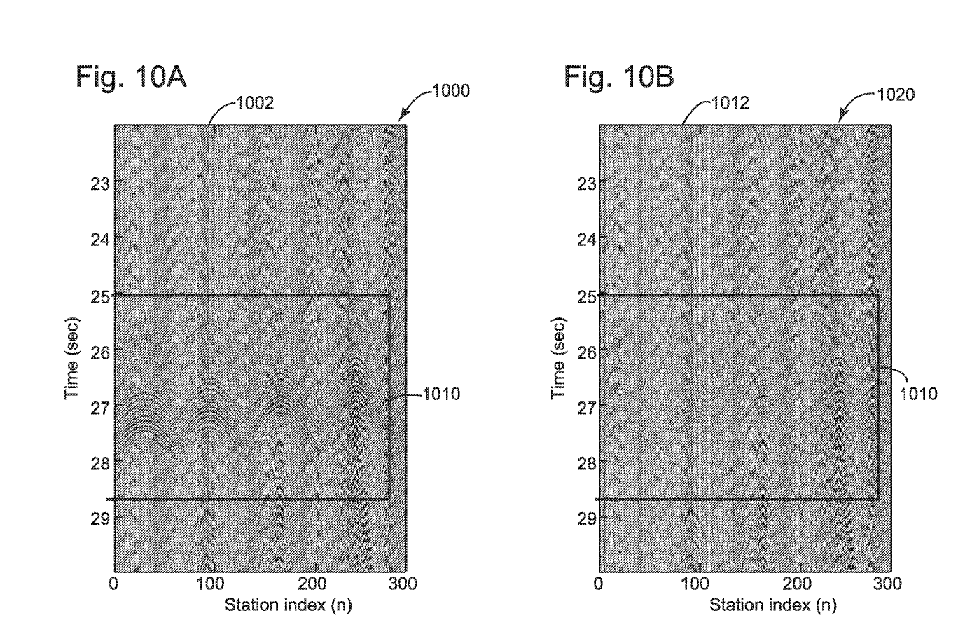

FIGS. 10A and 10B illustrate graphs 1000 and 1020 of the cross-correlation of a noise operator with a row stack in accordance with some embodiments of the present disclosure. FIG. 10A shows graph 1000 with data 1002. Data 1002 contains area 1010 that contains noise from the noise source associated with noise operator 912, discussed with reference to FIG. 9. FIG. 10B shows graph 1020 with data 1012. Data 1012 contains area 1010 that has noise attenuated by cross-correlation of data 1002 with noise operator 912. As can be seen, portions of the noise in area 1010 from data 1002 is somewhat removed in data 1012.

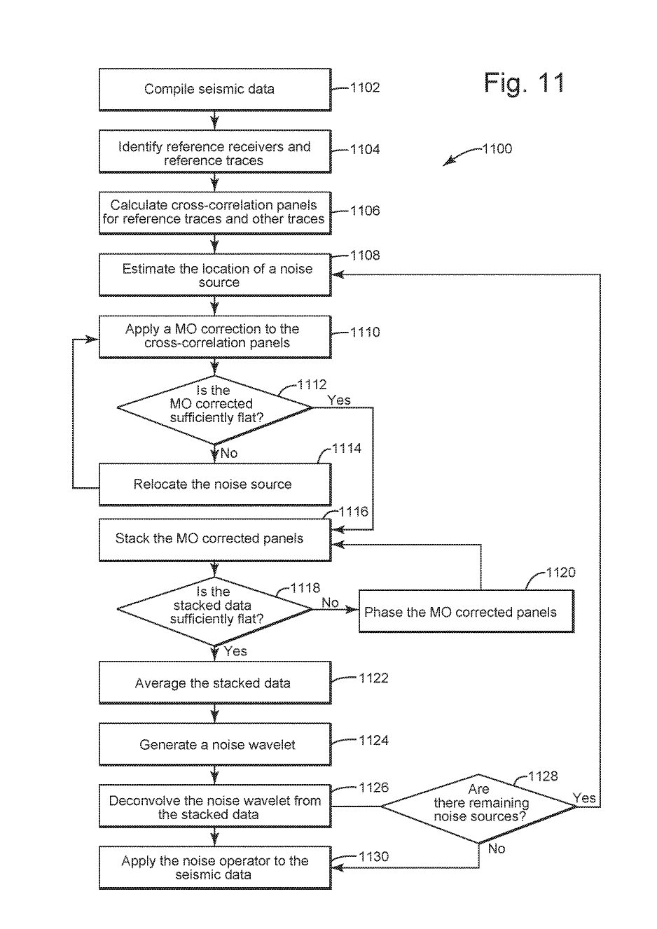

FIG. 11 illustrates a flow chart of an example method 1100 of attenuating noise using interferometric estimation in accordance with some embodiments of the present disclosure. The steps of method 1100 are performed by a user, various computer programs, models configured to process or analyze seismic data, or any combination thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “computing system.” For illustrative purposes, method 1100 is described with respect to seismic data 300 of FIG. 3; however, method 1100 may be used to attenuate noise using interferometric estimation for any suitable seismic data set.

Method 1100 starts at step 1102 where the computing system compiles, or otherwise obtains, a seismic data set from data generated by a plurality of receivers during a seismic exploration or survey. For example, a seismic data set may be generated by signals received by receivers 102 shown in FIG. 1. The seismic data is compiled or obtained by the computing system. For example, data 1002 shown in FIG. 10A may be compiled or obtained by the computing system.

At step 1104, the computing system identifies reference receivers and reference traces. For example, as discussed with reference to FIG. 3, the computing system may select a reference trace from reference receiver 102a shown in FIG. 1. In some embodiments, the computing system may successively identify some or all receivers as a reference receiver.

At step 1106, the computing system calculates cross-correlation panels for the reference trace from the reference receiver and some or all other traces from some or all of the other receivers. For example, cross-correlation panel 412 shown in FIG. 4 may be calculated. Noise energy, such as noise energy 410a, may be identified.

At step 1108, the computing system estimates the location of a noise source. For example, the location of the noise source that generated noise energy 410a may be estimated. The estimation may be based on the intensity or arrival times of noise energy 410a at each of the receivers that detected noise energy 410a.

At step 1110, the computing system applies an MO correction to the cross-correlation panels. For example, as discussed with reference to FIG. 5, an MO correction may be applied based on the estimated location of the noise source that generated noise energy 510a.

At step 1112, the computing system determines if the MO corrected data is sufficiently flat. The MO corrected panel generated in step 1110 may be examined to determine if the noise energy from the identified noise source is sufficiently flat. The flatness of the noise energy of interest relates to the accuracy of the estimated location of the noise source. If the noise energy in the MO corrected data is not sufficiently flat, method 1100 proceeds to step 1114.

At step 1114, the computing system relocates the noise source to improve the estimated location. Relocation is accomplished by updating the estimated location of the noise source. Method 1100 returns to step 1110 to reapply the MO correction to the cross-correlation panels based on the updated location of the noise source. For example, MO corrected panel 612, shown with reference to FIG. 6, may be the result after the noise source's location is updated and a revised MO correction is applied to the cross-correlated panels. Based on the resultant flatness of the noise energy of interest, another cycle of updating the location of the noise source may occur.

At step 1116, the computing system stacks the MO corrected panels. Stacking the MO corrected panels may result in noise energy that is easier to distinguish from the surrounding data. For example, as shown in FIG. 7, stacked panel 712 includes noise energy 710a that is easily identified. Identifying noise energy assists in phasing-in correlation panels from selected reference receivers to further stack the correlation panels together and decrease the residual unwanted noise in the correlation gathers.

At step 1118, the computing system may determine if the stacked panel is sufficiently flat. The stacked panel may be examined to determine if the noise energy of interest is sufficiently flat. If the noise energy of interest is not sufficiently flat in the stacked data, method 1100 proceeds to step 1120.

At step 1120, the computing system phases the MO corrected panels to remove any time differences. Time differences in the noise energy arrivals can be factored into the MO corrected panels to result in phased data that may include noise energy that is flatter than the MO corrected panels without phasing. Once the MO corrected panels are phased, method 1100 may return to step 1116.

If the noise energy of interest in the stacked panel is sufficiently flat at step 1118, method 1100 may proceed to step 1122. At step 1122, the computing system averages the stacked panels. For example, FIG. 8 shows averaged stacked panel 812 that exhibits visible noise energy 810a. Based on the averaged stacked panel, at step 1124, the computing system generates a noise wavelet. For example, noise wavelet 820 may be generated.

At step 1126, the computing system deconvolves or generates the noise wavelet from the stacked data to generate a noise operator. For example, noise wavelet 820 may be deconvolved from stacked panel 712 shown in FIG. 7. The result may be noise operator 912 shown in FIG. 9.

At step 1128, the computing system determines if additional noise sources remain to be identified in the correlations. If there are remaining noise sources, method 1100 may return to step 1108. If there are no additional noise sources, method 1100 may proceed to step 1130.

At step 1130, the computing system applies the noise operator to the seismic data to decrease or eliminate the contribution of noise to the seismic data. For example, noise operator 912 may be applied to seismic data 1002 shown in FIG. 10A. The result of applying the noise operator can be observed in data 1012 shown in FIG. 10B. A decrease in noise energy is seen in the comparison of area 1010 between FIGS. 10A and 10B. The noise-attenuated data may be used to generate an image of subsurface formations. In some embodiments, prior to applying the operator, the MO may be applied to the data to generate a synthetized noise wavelet. The synthetized noise wavelet may be convolved with the operator to result in an estimate of the noise under scrutiny over the receivers.

Modifications, additions, or omissions may be made to method 1100 without departing from the scope of the present disclosure. For example, the order of the steps may be performed in a different manner than that described and some steps may be performed at the same time. Additionally, each individual step may include additional steps without departing from the scope of the present disclosure.

The method described with reference to FIG. 11 and the prior figures is used to attenuate noise using interferometric estimation. FIG. 12 illustrates a schematic diagram of an example system 1200 that can be used to attenuate noise using interferometric estimation in accordance with some embodiments of the present disclosure. System 1200 includes one or more seismic energy sources 104, one or more receivers 102, and computing system 1210, which are communicatively coupled via network 1212. System 1200 is configured to produce imaging of the earth's subsurface geological formations.

Computing system 1210 can generate composite seismic images based on signals generated by a wide variety of sources 104. For example, computing system 1210 can operate in conjunction with sources 102 and receivers 102 having any structure, configuration, or function described above with respect to FIG. 1. In some embodiments, sources 104 may be impulsive (such as, for example, explosives or air guns) or vibratory. Impulsive sources may generate a short, high-amplitude seismic signal while vibratory sources may generate lower-amplitude signals over a longer period of time. Vibratory sources may generate a frequency sweep or may generate monofrequencies. Vibratory sources may be instructed, by means of a pilot signal, to generate a target seismic signal with energy at one or more desired frequencies, and these frequencies may vary over time.

In some embodiments, receivers 102 are not limited to any particular types of receivers. For example, in some embodiments, receivers 102 include geophones, hydrophones, accelerometers, fiber optic sensors (such as, for example, a distributed acoustic sensor (DAS)), streamers, or any suitable device. Such devices may be configured to detect and record energy waves propagating through the subsurface geology with any suitable, direction, frequency, phase, or amplitude. For example, in some embodiments, receivers 102 are vertical, horizontal, or multicomponent sensors. Receivers 102 can be three component (3C) geophones, 3C accelerometers, or 3C Digital Sensor Units (DSUs). In offshore embodiments, receivers 102 are situated on or below the ocean floor or other underwater surface. Furthermore, in some embodiments, seismic signals can be recorded with different sets of receivers 102. For example, some embodiments may use dedicated receiver spreads for each type of signal, though these receiver spreads may cover the same area, and each receiver spread can be composed of different types of receivers 102. Further, a positioning system, such as a global positioning system (GPS, GLONASS, etc.), may be utilized to locate or time-correlate sources 104 and receivers 102.

Sources 104 and receivers 102 may be communicatively coupled to computing system 1210. One or more receivers 102 transmit raw seismic data from received seismic energy via network 1212 to computing system 1210. A particular computing system 1210 may transmit raw seismic data to other computing systems or other site via a network. Computing system 1210 receives data recorded by receivers 104 and processes the data to generate a composite image or prepares the data for interpretation. Computing system 1210 may be operable to perform the processing techniques described above with respect to FIGS. 1-11.

Computing system 1210 may include any instrumentality or aggregation of instrumentalities operable to compute, classify, process, transmit, receive, store, display, record, or utilize any form of information, intelligence, or data. For example, computing system 1210 may be one or more mainframe servers, desktop computers, laptops, cloud computing systems, storage devices, or any other suitable devices and may vary in size, shape, performance, functionality, and price. Computing system 1210 may include random access memory (RAM), one or more processing resources such as a central processing unit (CPU) or hardware or software control logic, or other types of volatile or non-volatile memory. Additional components of computing system 1210 may include one or more disk drives, one or more network ports for communicating with external devices, various input and output (I/O) devices, such as a keyboard, a mouse, and a video display. Computing system 1210 may be configured to permit communication over any type of network 1212. Network 1212 can be a wireless network, a local area network (LAN), a wide area network (WAN) such as the Internet, or any other suitable type of network.

Network interface 1214 represents any suitable device operable to receive information from network 1212, transmit information through network 1212, perform suitable processing of information, communicate with other devices, or any combination thereof. Network interface 1214 may be any port or connection, real or virtual, including any suitable hardware and/or software (including protocol conversion and data processing capabilities) that communicates through a LAN, WAN, or other communication system. This communication allows computing system 1210 to exchange information with network 1212, other computing systems 1210, sources 104, receivers 102, or other components of system 1200. Computing system 1210 may have any suitable number, type, and/or configuration of network interface 1214.

Processor 1216 communicatively couples to network interface 1214 and memory 1218 and controls the operation and administration of computing system 1210 by processing information received from network interface 1214 and memory 1218. Processor 1216 includes any hardware and/or software that operates to control and process information. In some embodiments, processor 1216 may be a programmable logic device, a microcontroller, a microprocessor, any suitable processing device, or any suitable combination of the preceding. Computing system 1210 may have any suitable number, type, and/or configuration of processor 1216. Processor 1216 may execute one or more sets of instructions to implement the generation of a composite image based on seismic data, including the steps described above with respect to FIGS. 1-11. Processor 1216 may also execute any other suitable programs to facilitate the generation of broadband composite images such as, for example, user interface software to present one or more GUIs to a user.

Memory 1218 stores, either permanently or temporarily, data, operational software, or other information for processor 1216, other components of computing system 1210, or other components of system 1200. Memory 1218 includes any one or a combination of volatile or nonvolatile local or remote devices suitable for storing information. For example, memory 1218 may include random access memory (RAM), read only memory (ROM), flash memory, magnetic storage devices, optical storage devices, network storage devices, cloud storage devices, solid-state devices, external storage devices, any other suitable information storage device, or a combination of these devices. Memory 1218 may store information in one or more databases, file systems, tree structures, any other suitable storage system, or any combination thereof. Furthermore, different types of information stored in memory 1218 may use any of these storage systems. Moreover, any information stored in memory may be encrypted or unencrypted, compressed or uncompressed, and static or editable. Computing system 1210 may have any suitable number, type, and/or configuration of memory 1218. Memory 1218 may include any suitable information for use in the operation of computing system 1210. For example, memory 1218 may store computer-executable instructions operable to perform the steps discussed above with respect to FIGS. 1-11 when executed by processor 1216. Memory 1218 may also store any seismic data or related data such as, for example, raw seismic data, reconstructed signals, velocity models, seismic images, or any other suitable information.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. For example, seismic sources 104 in FIGS. 1 and 12 may be any combination of vibratory or impulsive seismic sources. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability. For example, the computing system described in method 1100 with respect to FIG. 11 may be stored in tangible computer readable storage media.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

What is claimed is:

1. A method for seismic acquisition comprising:
compiling a seismic data set from data received from a plurality of receivers, the seismic data set including noise energy from a noise source;
calculating a plurality of cross-correlation panels based on a reference trace from a reference receiver, the reference receiver being one of the plurality of receivers;
estimating the location of the noise source;
applying a correction to the plurality of cross-correlation panels based on the estimated location of the noise source thereby generating a plurality of corrected panels; and
analyzing the plurality of corrected panels for a noise operator to attenuate noise in the seismic data set.

2. The method of claim 1, wherein analyzing the plurality of corrected panels includes:
stacking the plurality of corrected panels;
generating a noise wavelet based on the stacked corrected panel; and
generating a noise operator based on the noise wavelet.

3. The method of claim 2, further comprising applying the noise operator to the seismic data set.

4. The method of claim 2, further comprising:
determining if the stacked corrected panel is coherent based on the noise energy in the plurality of corrected panels being sufficiently flat; and
based on determining that the stacked corrected panel is not coherent, updating the estimated location of the noise source.

5. The method of claim 2, wherein generating the noise operator includes deconvolving the noise wavelet from the stacked corrected panel.

6. The method of claim 1, wherein the correction applied to the plurality of cross-correlation panels is a move out correction.

7. The method of claim 1, further comprising phasing the plurality of corrected panels.

8. A seismic processing system, comprising:
a computing system operable to receive seismic data from a plurality of receivers and configured to:
compile a seismic data set from the seismic data received from the plurality of receivers, the seismic data set including noise energy from a noise source;
calculate a plurality of cross-correlation panels based on a reference trace from a reference receiver, the reference receiver being one of a plurality of receivers;
estimate the location of the noise source;
apply a correction to the plurality of cross-correlation panels based on the estimated location of the noise source thereby generating a plurality of corrected panels; and
analyze the plurality of corrected panels for a noise operator to attenuate noise in the seismic data set.

9. The system of claim 8, wherein analyzing the plurality of corrected panels includes:
stacking the plurality of corrected panels;
generating a noise wavelet based on the stacked corrected panel; and
generating a noise operator based on the noise wavelet.

10. The system of claim 9, wherein the computing system is further configured to apply the noise operator to the seismic data set.

11. The system of claim 9, wherein the computing system is further configured to:
determine if the stacked corrected panel is coherent based on the noise energy in the plurality of corrected panels being sufficiently flat; and
based on determining that the stacked corrected panel is not coherent, update the estimated location of the noise source.

12. The system of claim 9, wherein generating the noise operator includes deconvolving the noise wavelet from the stacked corrected panel.

13. The system of claim 8, wherein the correction applied to the plurality of cross-correlation panels is a move out correction.

14. The system of claim 8, wherein the computing system is further configured to phase the plurality of corrected panels.

15. A non-transitory computer-readable medium, comprising:
computer-executable instructions carried on the computer-readable medium, the instructions, when executed, causing a processor to:
compile a seismic data set from data received by the plurality of receivers, the seismic data set including noise energy from a noise source;
calculate a plurality of cross-correlation panels based on a reference trace from a reference receiver, the reference receiver being one of the plurality of receivers;
estimate the location of the noise source;
apply a correction to the plurality of cross-correlation panels based on the estimated location of the noise source generating a plurality of corrected panels; and
analyze the plurality of corrected panels for a noise operator to attenuate noise in the seismic data set.

16. The non-transitory computer-readable medium of claim 15, wherein analyzing the plurality of corrected panels includes:
stacking the plurality of corrected panels;
generating a noise wavelet based on the stacked corrected panel; and
generating a noise operator based on the noise wavelet.

17. The non-transitory computer-readable medium of claim 15, wherein the processor is further caused to apply the noise operator to the seismic data set.

18. The non-transitory computer-readable medium of claim 16, wherein the processor is further caused to:
determine if the stacked corrected panel is coherent based on the noise energy in the plurality of corrected panels being sufficiently flat; and
based on determining that the stacked corrected panel is not coherent, update the estimated location of the noise source.

19. The non-transitory computer-readable medium of claim 16, wherein generating the noise operator includes deconvolving the noise wavelet from the stacked corrected panel.

20. The non-transitory computer-readable medium of claim 15, wherein the correction applied to the plurality of cross-correlation panels is a move out correction.
